(19) United States
(12) Patent Application Publication
(10) Pub. No.: US 2024/0142788 A1
(43) Pub. Date: May 2, 2024

(54) METHOD AND SYSTEM FOR LIGHT EMITTING DIODE (LED) ILLUMINATION SOURCE

(71) Applicant: Texas Instruments Incorporated, Dallas, TX (US)

(72) Inventors: Gregory S. Pettitt, Durant, OK (US); John M. Gerri, Allen, TX (US)

(73) Assignee: Texas Instruments Incorporated, Dallas, TX (US)

(21) Appl. No.: 18/452,832

(22) Filed: Aug. 21, 2023

Related U.S. Application Data
(60) Provisional application No. 63/380,951, filed on Oct. 26, 2022.

(51) Int. Cl. G02B 27/30; G02B 27/01

(52) U.S. Cl. CPC G02B 27/30; G02B 27/0172

(57) ABSTRACT

A system includes an LED assembly including a first LED, the first LED configured to produce first light having a first color, a second LED adjacent the first quadrant, the second LED configured to produce second light having a second color, a third LED adjacent the second quadrant, the third LED configured to produce third light having a third color, and a fourth LED adjacent the third quadrant and the first quadrant, the fourth LED configured to produce fourth light having the third color. The system includes a reflective element having a first surface and a second surface, the first surface configured to reflect the first light towards a homogenizing element and to reflect the second light towards the homogenizing element, and the second surface configured to reflect the third light towards the homogenizing element and to reflect the fourth towards the homogenizing element.

### CROSS-REFERENCE TO RELATED APPLICATION

This application claims priority to U.S. Provisional Patent Application No. 63/380,951, filed on Oct. 26, 2022, and entitled “Reduced Size LED Illumination Design for Compact Display Systems,” which application is hereby incorporated herein by reference in its entirety.

### TECHNICAL FIELD

The present application relates in general to illumination, and, in particular, to a method and system for light emitting diode (LED) illumination source.

### BACKGROUND

Projection displays are used in many applications, for example near-eye displays such as augmented reality (AR) and virtual reality (VR). Near-eye displays may illuminate a spatial light modulator (SLM) by an illumination source. In near-eye displays, it is desirable to have a compact size for the entire system, including for the illumination source. It is also desirable to have an efficient light utilization and low power consumption.

### SUMMARY

An embodiment includes system including a light emitting diode (LED) assembly. The LED assembly includes a first LED in a first quadrant of the LED assembly, the first LED configured to produce first light having a first color, a second LED in a second quadrant of the LED assembly adjacent the first quadrant, the second LED configured to produce second light having a second color, a third LED in a third quadrant of the LED assembly adjacent the second quadrant, the third LED configured to produce third light having a third color, and a fourth LED in a fourth quadrant of the LED assembly adjacent the third quadrant and the first quadrant, the fourth LED configured to produce fourth light having the third color. The system also includes a homogenizing element and a reflective element having a first surface and a second surface. The reflective element is optically coupled to the LED assembly and to the homogenizing element, the first surface is configured to reflect the first light having the first color towards the homogenizing element and to reflect the second light having the second color towards the homogenizing element, and the second surface configured to reflect the third light having the third color towards the homogenizing element and to reflect the fourth light having the third color towards the homogenizing element.

An embodiment includes a near-eye display including a light emitting diode (LED) assembly. The LED assembly includes a first LED in a first quadrant of the LED assembly, the first LED configured to produce first light having a first color, a second LED in a second quadrant of the LED assembly adjacent the first quadrant, the second LED configured to produce second light having a second color, a third LED in a third quadrant of the LED assembly adjacent the second quadrant, the third LED configured to produce third light having a third color, and a fourth LED in a fourth quadrant of the LED assembly adjacent the third quadrant and the first quadrant, the fourth LED configured to produce fourth light having the third color. The near-eye display also includes a homogenizing element and a reflective element having a first surface and a second surface. The reflective element is optically coupled to the LED assembly and to the homogenizing element, the first surface configured to reflect the first light having the first color towards the homogenizing element and to reflect the second light having the second color towards the homogenizing element, and the second surface configured to reflect the third light having the third color towards the homogenizing element and to reflect the fourth light having the third color towards the homogenizing element. Additionally, the near-eye display includes illumination optics optically coupled to the homogenizing element and a spatial light modulator (SLM). The near-eye display also includes projection optics, a prism optically coupled to the illumination optics, to the SLM, and to the projection optics, and a waveguide optically coupled to the projection optics.

An embodiment includes a method including producing, by a first light emitting diode (LED) in a first quadrant of an LED assembly, first light having a first color and producing, by a second LED in a second quadrant of the LED assembly adjacent the first quadrant, second light having a second color. The method also includes producing, by a third LED in a third quadrant of the LED assembly adjacent the second quadrant, third light having a third color and producing, by a fourth LED in a fourth quadrant of the LED assembly adjacent the third quadrant and the first quadrant, fourth light having the third color. Additionally, the method includes reflecting, by a first surface of a reflective element, the first light having the first color towards a homogenizing element and reflecting, by the first surface of the reflective element, the second light having the second color towards the homogenizing element. Also, the method includes reflecting, by a second surface of the reflective element, the third light having the third color towards the homogenizing element and reflecting, by the second surface of the reflective element, the fourth light having the third color towards the homogenizing element.

### BRIEF DESCRIPTION OF THE DRAWINGS

For a more complete understanding of the illustrative examples of aspects of the present application that are described herein and the advantages thereof, reference is now made to the following descriptions taken in conjunction with the accompanying drawings, in which:

FIG. 1 illustrates a functional block diagram of an example near-eye display with a light emitting diode (LED) illumination source;

FIG. 2A illustrates an example light emitting diode (LED) illumination source;

FIG. 2B illustrates an example LED assembly;

FIG. 2C illustrates another example LED assembly;

FIG. 2D illustrates an additional LED assembly;

FIG. 2E illustrates another LED assembly;

FIG. 2F illustrates another example LED illumination source;

FIG. 3 illustrates another example near-eye display with an LED illumination source;

FIG. 4 illustrates an additional near-eye display with an LED illumination source; and

FIG. 5 illustrates a flowchart for an embodiment method of LED illumination.

Corresponding numerals and symbols in the different figures generally refer to corresponding parts unless otherwise indicated. The figures are drawn to clearly illustrate the relevant aspects of the illustrative example arrangements and are not necessarily drawn to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

In this description, elements that are optically coupled have an optical connection between the elements, but various intervening optical components can exist between elements that are optically coupled.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

Although the example illustrative arrangements have been described in detail, it should be understood that various changes, substitutions and alterations can be made herein without departing from the spirit and scope of the present application as defined by the appended claims.

Projection displays may have an illumination light source optically coupled to a spatial light modulator (SLM). For near-eye displays such as augmented reality (AR) and virtual reality (VR), it is desirable to have an illumination light source that is very compact while being low in power consumption and high in brightness. A near-eye display may be a wearable device. In an embodiment, an illumination light source includes a light emitting diode (LED) assembly optically coupled to a reflective element. The illumination light source may include a first LED in a first quadrant of the LED assemble, a second LED in a second quadrant of the LED assembly adjacent the first LED, a third LED in a third quadrant adjacent the fourth quadrant, and a fourth LED in a fourth quadrant adjacent the third quadrant and the fourth quadrant. In an example, the first LED produces first light having a first color, the second LED produces second light having a second color, the third LED segment produces third light having a third color, and the fourth LED produces fourth light having the third color. The reflective element is optically coupled to a homogenizing element. In an example, the reflective element has a first surface configured to reflect light having the first color and the second color and a second surface configured to reflect light having the third color.

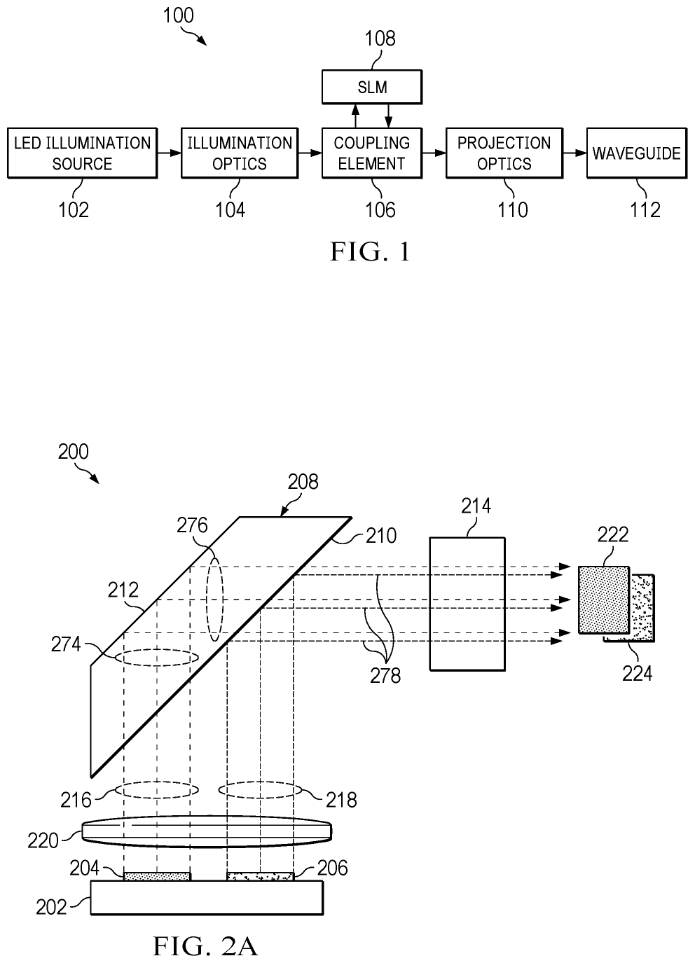

FIG. 1 illustrates a functional block diagram of an example near-eye display 100 with an LED illumination source 102. In an example, the near-eye display 100 is part of a wearable device. In an example, a wearable device contains two near-eye displays 100, one for each eye. In an embodiment, the LED illumination source 102 includes a light emitting diode (LED) assembly optically coupled to a reflective element. The illumination light source may include a first LED in a first quadrant of the LED assemble, a second LED in a second quadrant of the LED assembly adjacent the first LED, a third LED in a third quadrant adjacent the fourth quadrant, and a fourth LED in a fourth quadrant adjacent the third quadrant and the fourth quadrant. In an example, the first LED produces first light having a first color, the second LED produces second light having a second color, the third LED segment produces third light having a third color, and the fourth LED produces fourth light having the third color. The reflective element is optically coupled to a homogenizing element. In an example, the reflective element has a first surface configured to reflect light having the first color and the second color and a second surface configured to reflect light having the third color. The first surface reflects the light having the first color and the second color towards the homogenizing element, and the second surface reflects the light having the third color towards the homogenizing element. The homogenizing element homogenizes the light having the first color, the second color, and the third color to produce homogenized light.

The LED illumination source 102 is optically coupled to illumination optics 104, and the illumination optics 104 is optically coupled to a coupling element 106. The coupling element 106 is optically coupled to the illumination optics 104, to a spatial light modulator (SLM) 108, and to projection optics 110. The projection optics 110 is optically coupled to a waveguide 112. The illumination optics 104 directs the homogenized light towards the coupling element 106 as first focused light. The illumination optics 104 contains one or more optical elements. In one example, the illumination optics 104 is a lens assembly. In another example, the illumination optics 104 includes two lenses and a prism.

The coupling element 106 directs the first focused light towards the SLM 108. The focused light enters the prism at an angle at which the focused light proceeds to the. In an example, the coupling element includes one or more prism, for example a total internal reflection (TIR) prism, a reverse total internal reflection (RTIR) prism, or a polarizing beam splitter prism. In other examples, the coupling element is a thin reflective polarizing beam splitter plate. The SLM 108 modulates the focused light to produce modulated light. The SLM 108 may be a digital micromirror device (DMD) device, a liquid crystal on silicon (LCoS) device, a liquid crystal display (LCD), or another SLM. The SLM 108 contains pixels which modulate the focused light to produce an image in the modulated light. In an example in which the coupling element 106 is a prism, the coupling element 106 directs the modulated light towards the SLM 108 using either total internal reflection (TIR) in the case that the SLM is a microelectromechanical system (MEMS) array such as a DMD or the prism reflects light toward the SLM using a polarizing beam splitter in the case where the SLM is a LCD or LCoS panel.

The projection optics 110 direct the modulated light received from the coupling element 106 towards the waveguide 112 as projected light. In one example, the projection optics 110 include multiple lenses, for example four lenses. In another example, the projection optics 110 is a freeform optical element.

The waveguide 112 directs the projected light towards the eye of a user for viewing the image formed by the SLM 108.

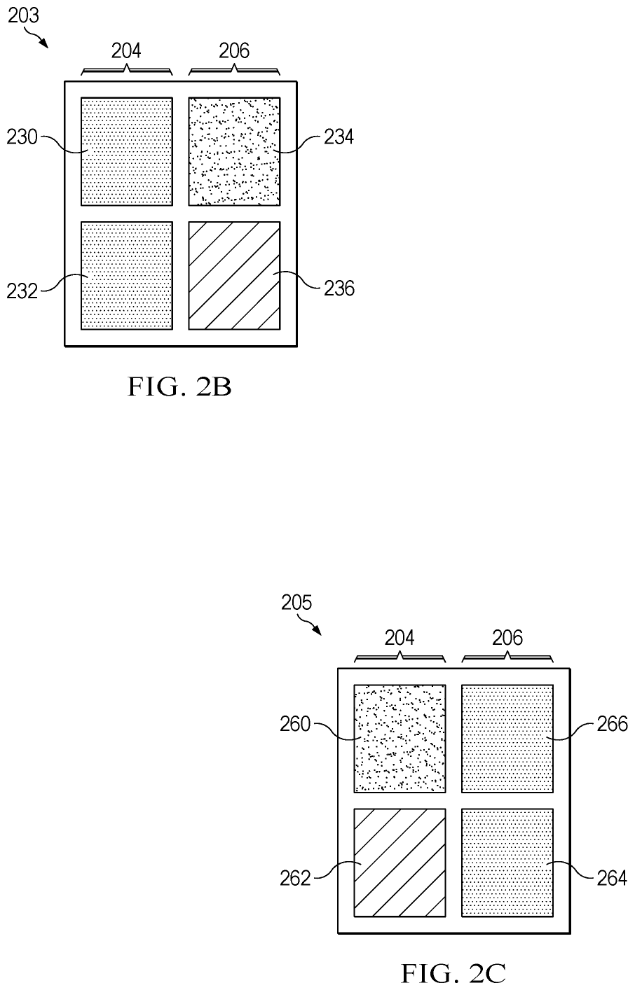

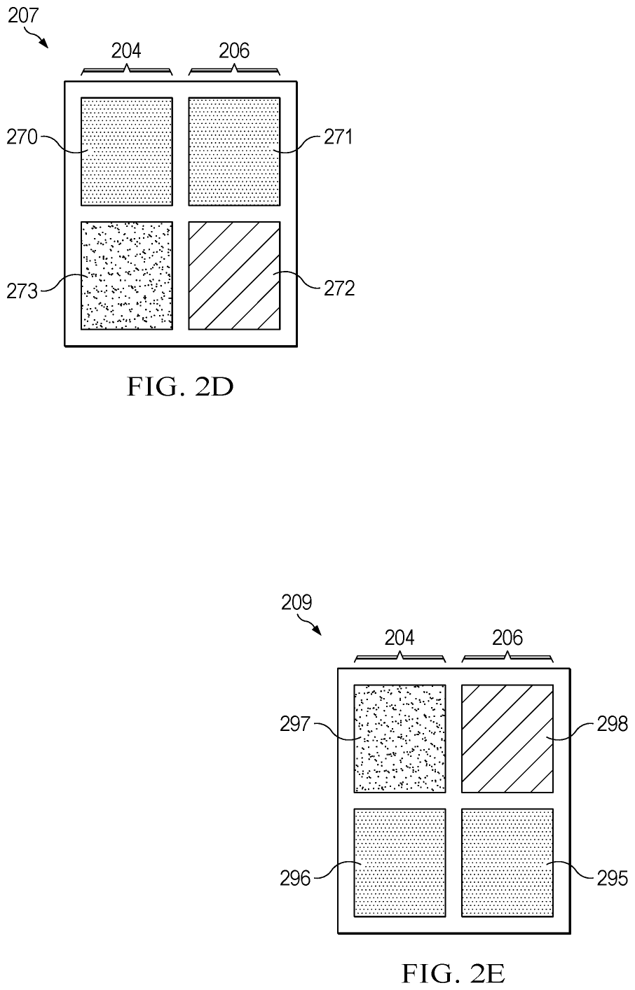

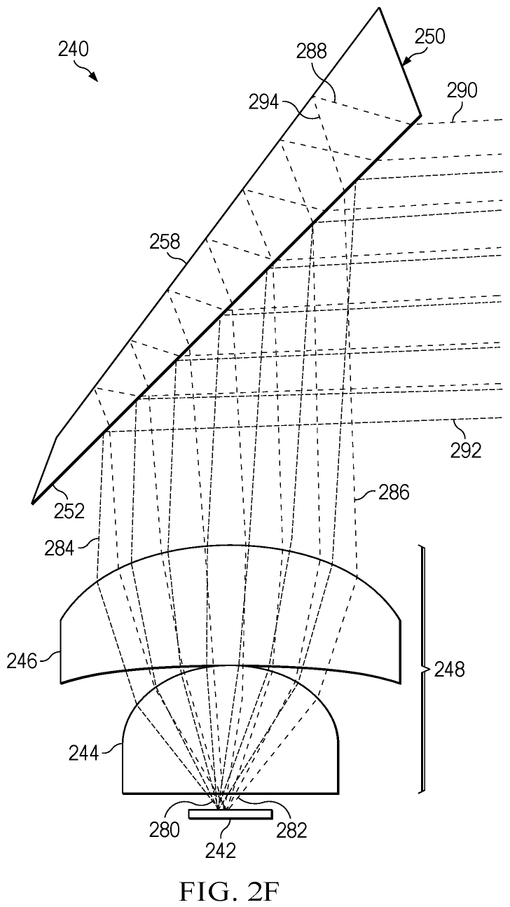

FIG. 2A illustrates an example LED illumination source 200. The LED illumination source 200 may be an example of the LED illumination source 102 illustrated in FIG. 1. The LED illumination source 200 includes a reflective element 208 optically coupled to an LED assembly 202 and to a homogenizing element 214.

FIG. 2B illustrates a top view of an example of the LED assembly 203, which may be an example of the LED assembly 202 illustrated in FIG. 2A. The LED assembly 203 has an LED 234 in a first quadrant of the LED assembly 203, an LED 236 in a second quadrant of the LED assembly 203 adjacent the first quadrant, an LED 232 in the third quadrant of the LED assembly 203 adjacent the second quadrant, and an LED 230 in the fourth quadrant of the LED assembly 203 adjacent the third quadrant and the first quadrant. The LED 234 produces first light having a first color, the LED 236 produces second light having a second color different than the first color, the LED 232 produces third light having a third color different than the first color and the second color, and the LED 230 produces fourth light having the third color. The LED 230, which is adjacent the LED 232, produce light having the same color. In an example, the first color is red, the second color is blue, and the third color is green. In another example, the first color is blue, the second color is red, and the third color is green. The LED 234 and the LED 236 are in a column 204, and the LED 230 and the LED 232 are in a column 204. The LEDs in the column 204, the LED 234 and the LED 236, produce the light 216 having the third color. Also, the LEDs in the column 204, the LED 230 and the LED 232, produce the light 218 having the first color and the second color. The column 204 and the column 206 are also illustrated in FIG. 2A.

FIG. 2C illustrates a top view of another example of the LED assembly 205, which may be an example of the LED assembly 202 illustrated in FIG. 2A. The LED assembly 205 contains an LED 262 in a first quadrant, an LED 260 in a second quadrant adjacent the first quadrant, an LED 266 in the third quadrant adjacent the second quadrant, and an LED 264 in a fourth quadrant adjacent the third quadrant and the first quadrant. The LED 262 produces first light having a first color, the LED 260 produces second light having a second color different than the first color, the LED 266 produces third light having a third color different than the first color and the second color, and the LED 264 produces fourth light having the third color. The LED 266 and the LED 264 produce light having the same color. In an example, the first color is blue, the second color is red, and the third color is green. In another example, the first color is red, the second color is blue, and the third color is green. The LED 260 and the LED 262 are in the column 204 and the LED 266 and the LED 264 are in the column 206. The LED 260 and the LED 262 in the column 204 produce the light 216 having the first color and the second color, and the LED 266 and the LED 264 in the column 206 produce the light 218 having the third color. The column 204 and the column 206 are also illustrated in FIG. 2A.

FIG. 2D illustrates a top view of another example of the LED assembly 207, which may be an example of the LED assembly 202 illustrated in FIG. 2A. The LED assembly 207 contains an LED 273 in a first quadrant, an LED 272 in a second quadrant adjacent the first quadrant, an LED 271 in the third quadrant adjacent the second quadrant, and an LED 270 in a fourth quadrant adjacent the third quadrant and the first quadrant. The LED 273 produces first light having a first color, the LED 272 produces second light having a second color different than the first color, the LED 271 produces third light having a third color different than the first color and the second color, and the LED 270 produces fourth light having the third color. The LED 271 and the LED 270 produce light having the same color. In an example, the first color is blue, the second color is red, and the third color is green. In another example, the first color is red, the second color is blue, and the third color is green. The LED 270 and the LED 273 are in the column 204 and the LED 271 and the LED 272 are in the column 206. The LED 270 and the LED 273 in the column 204 produce the light 216 having the third color and the second color, and the LED 271 and the LED 272 in the column 206 produce the light 218 having the third color and the first color. The column 204 and the column 206 are also illustrated in FIG. 2A.

FIG. 2E illustrates a top view of another example of the LED assembly 209, which may be an example of the LED assembly 202 illustrated in FIG. 2A. The LED assembly 209 contains an LED 297 in a first quadrant, an LED 298 in a second quadrant adjacent the first quadrant, an LED 295 in the third quadrant adjacent the second quadrant, and an LED 296 in a fourth quadrant adjacent the third quadrant and the first quadrant. The LED 297 produces first light having a first color, the LED 298 produces second light having a second color different than the first color, the LED 295 produces third light having a third color different than the first color and the second color, and the LED 296 produces fourth light having the third color. The LED 295 and the LED 296 produce light having the same color. In an example, the first color is blue, the second color is red, and the third color is green. In another example, the first color is red, the second color is blue, and the third color is green. The LED 297 and the LED 296 are in the column 204 and the LED 298 and the LED 295 are in the column 206. The LED 297 and the LED 296 in the column 204 produce the light 216 having the first color and the third color, and the LED 298 and the LED 295 in the column 206 produce the light 218 having the second color and the third color. The column 204 and the column 206 are also illustrated in FIG. 2A.

Returning to FIG. 2A, a lens assembly 220 is optically coupled to the LED assembly 202. In FIG. 2A, the lens assembly 220 is illustrated as containing one lens for simplicity, but the lens assembly 220 may contain more lenses, for example two lenses or three lenses. The reflective element 208 is optically coupled to the lens assembly 220. The lens assembly 220 focuses the light 216 and the light 218 towards the reflective element 208. The reflective element 208 has a surface 210 and a surface 212, which are reflective surfaces. The surface 210 is at an angle with respect to the surface 212 such that the reflected light 276 and the reflected light 278 are approximately parallel. In one example, the reflective element 208 is a single element, for example composed of glass or plastic, with a reflective coating on the surface 210 and a reflective coating on the surface 212. The surface 210 is on a first side of the transmissive element and the surface 212 is on a second side of the transmissive element. In another example, the surface 210 is a reflective plate and the surface 212 is a reflective plate spaced away from the surface 210, for example by an air gap between the surface 210 and the surface 212. The surface 210 is a dichroic mirror that reflects the light 218 to produce reflected light 278 and transmits the light 216 to produce transmitted light 274. In one example the light 218 has the first color and the second color, for example red light and blue light, and the light 216 has the third color, for example green. In this example, the surface 210 transmits green light and reflects blue light and red light. In another example, the light 218 has the third color, for example green, and the light 216 has the first color and the second color, for example blue and red. In this example, the surface 210 transmits red and blue light and reflects green light. The surface 212 reflects the transmitted light 274 to produce reflected light 276. The reflected light 276 is then transmitted by the surface 210. In one example, the surface 212 is a minor that reflects light having any color. In another example, the surface 212 is a dichroic mirror that reflects the transmitted light 274. In one example, the transmitted light 274 has the third color, for example green, and the surface 212 is configured to reflect light having the third color and to transmit light having the first color and the second color. In another example, the transmitted light 274 has the first color and the second color, for example red light and blue light, and the surface 212 reflects the first color and the second color and transmits light having the third color. The reflected light 278 is transmitted by the surface 210. The reflected light 278 is slightly offset from the reflected light 276.

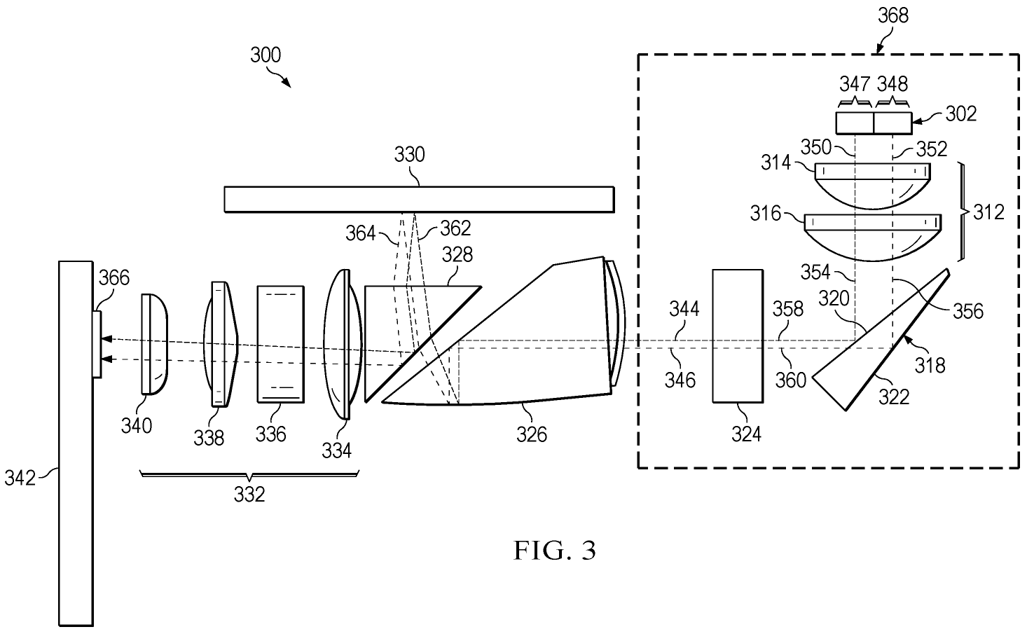

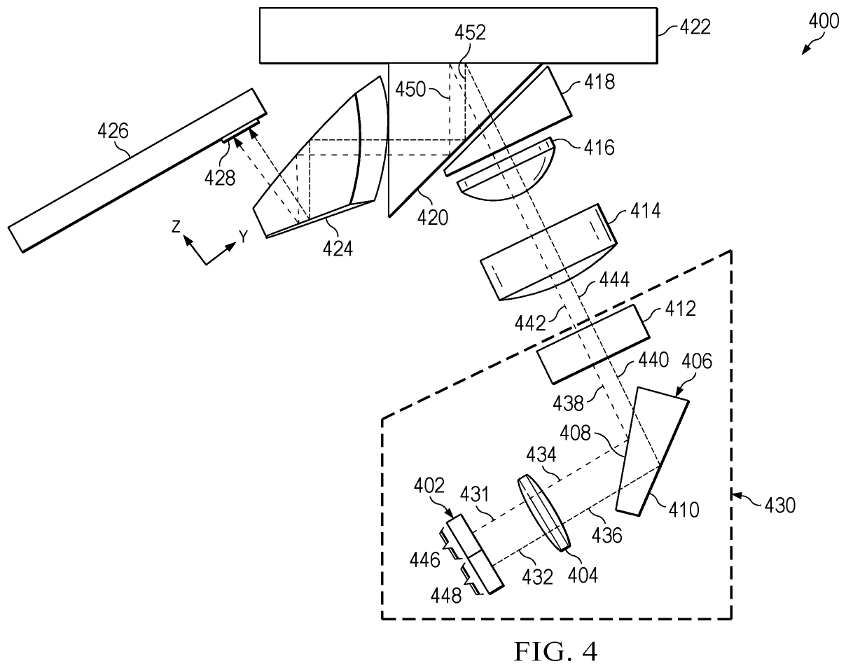

The homogenizing element 214 is optically coupled to the reflective element 208. The homogenizing element 214 provides uniform illumination of the SLM (not pictured in FIG. 2A, but pictured in FIGS. 3 and 4). The reflective element 208 directs the reflected light 276 and the reflected light 278 towards the homogenizing element 214. The homogenizing element mixes the reflected light 276 and the reflected light 278 to produce the output light 222 and the output light 224, respectively. In one example, the homogenizing element 214 is a fly's eye array. In another example, the homogenizing element 214 is a light tunnel.

The LED illumination source 200 is very compact, which is important to many projection applications, especially for near-eye displays. The use of the LED assembly 202, in which the two LEDs having the same color are adjacent, combined with the reflective element 208, enable a compact LED illumination source 200 with a high coupling efficiency. The position of two LEDs having the same color being adjacent to each other facilitates a smaller and more efficient optical design. The use of an LEDs as the light source in the LED assembly 202 enables a high brightness with a relatively low power consumption and a high coupling efficiency. In an example the homogenizing element 214 being a fly's eye array also assists in the compact size of the LED illumination source 200. The LED assembly 202 having two LEDs of the same color, for example green, improves the brightness by preventing the green illumination from limiting the brightness.

FIG. 2F illustrates an example LED illumination source 240. The LED illumination source 240 may be an example of the LED illumination source 102 illustrated in FIG. 1 or the LED illumination source 200 illustrated in FIG. 2A. The LED illumination source 240 contains an LED assembly 242 optically coupled to a lens assembly 248 and to a reflective element 250. The LED assembly 242 may be an example of the LED assembly 202 illustrated in FIG. 2A, the LED assembly 203 illustrated in FIG. 2B, the LED assembly 205 illustrated in FIG. 2C, the LED assembly 207 illustrated in FIG. 2D, or the LED assembly 209 illustrated in FIG. 2E. The lens assembly 248 may be an example of the lens assembly 220 illustrated in FIG. 2A. The reflective element 250 may be an example of the reflective element 208 illustrated in FIG. 2A. The LED assembly 242 produces light 280 by a first column and produces light 282 by a second column. In one example, the light 280 has a first color and a second color, for example red and blue, and the light 282 has a third color, for example green. In another example, the light 280 has the third color, for example green, and the light 282 has the first color and the second color, for example red and blue. The lens assembly 248 contains a lens 244 and a lens 246. The lens assembly 248 focuses the light 280 towards the reflective element as focused light 284 and focuses the light 282 towards the reflective element 250 as light 286.

The reflective element 250 has a surface 252 and a surface 258. In the illustrated example, the reflective element 250 is a transmissive element, for example composed of glass or plastic, with a reflective coating at the surface 252 and a reflective coating at the surface 258. The surface 252 is on a first side of the transmissive element and the surface 258 is on a second side of the transmissive element. The surface 252 transmits the focused light 286 as the light 294 and reflects the light 284 as reflected light 292. The surface 258 reflects the light 294 as light 288. The surface 258 may be a minor that reflects all light or a dichroic mirror that reflects the light 288 and transmits light having a different color. The surface 252 then transmits the light 288 as the reflected light 290. The reflected light 290 is slightly offset from the reflected light 292.

FIG. 3 illustrates another example near-eye display 300 with an LED illumination source 368. The near-eye display 300 may be an example of the near-eye display 100 illustrated in FIG. 1. In an example, a wearable device contains two of the near-eye display 300, one for each eye. The LED illumination source 368 may be an example of the LED illumination source 102 illustrated in FIG. 1, the LED illumination source 200 illustrated in FIG. 2A, or the LED illumination source 240 illustrated in FIG. 2F. The LED illuminations source 368 includes an LED assembly 302, a lens assembly 312, a reflective element 318, and a homogenizing element 324.

The LED assembly 302 may include the LED assembly 203 illustrated in FIG. 2B, the LED assembly 205 illustrated in FIG. 2C, the LED assembly 207 illustrated in FIG. 2D, or the LED assembly 209 illustrated in FIG. 2D. The LED assembly 302 contains four LEDs in a square configuration. Two LEDs are in column 347 that produce light 350 and two LEDs are in column 348 and produce light 352. In an example, the LED assembly 302 contains two LEDs in a column 347 and two LEDs in a column 348. In one example, the column 346 has a first LED in a first quadrant and a second LED in a second quadrant adjacent the first quadrant. The first LED produces first light having a first color, for example red light or blue light, and the second LED produces second light having a second color different than the first color, for example blue light or red light. In this example, the column 348 has a third LED in a third quadrant adjacent the second quadrant and a fourth LED in a fourth quadrant adjacent the third quadrant and the first quadrant. The third LED and the fourth LED produce third light and fourth light, respectively, having a third color different than the first color and the second color, for example green. In another example, the column 348 has a first LED in a first quadrant and a second LED in the second quadrant, the second quadrant adjacent the first quadrant. The first LED produces first light having a first color, for example red or blue, and the second LED produces second light having a second color different than the first color, for example blue or red. The column 346 has a third LED in a third quadrant adjacent the second quadrant and a fourth LED in a fourth quadrant adjacent the third quadrant and the first quadrant. The third LED is configured to produce third light having a third color different than the first color and the second color, for example green, and the fourth LED is configured to produce fourth light having the third color, for example green.

The lens assembly 312 is optically coupled to the LED assembly 302. The lens assembly 312 includes a lens 314 and a lens 316. The lens assembly 312 focuses the light 350 to produce focused light 354. Also, the lens assembly 312 focuses the light 352 to produce focused light 356.

The reflective element 318 is optically coupled to the lens assembly 312 and to the homogenizing element 324. The reflective element 318 has a surface 320 and a surface 322. In one example, the surface 320 and the surface 322 are reflective plates, where the reflective plates are spaced from each other, for example by an air gap. In other examples, the reflective element 318 is a transmissive element, for example composed of glass or plastic, and the surface 320 and the surface 322 are reflective surfaces on the transmissive element. The surface 320 reflects the focused light 354 to produce reflected light 358. The surface 320 also transmits the focused light 356, which is reflected by the surface 322 and again transmitted by the surface 320 to produce reflected light 360.

The homogenizing element 324 is optically coupled to the reflective element 318. The homogenizing element 324 may be a fly's eye array or a light tunnel. The homogenizing element 324 homogenizes the reflected light 358, to produce the reflected light 344. The homogenizing element 324 also homogenizes the reflected light 360 to produce the reflected light 346.

An optical assembly 326 is optically coupled to the homogenizing element 324. The optical assembly 326 may be an example of the illumination optics 104 illustrated in FIG. 1. The reflected light 344 and 346 enter the optical assembly 326 and are reflected twice before being transmitted towards a prism 328. The prism 328 is an example of the coupling element 106 illustrated in FIG. 1. The prism 328 is optically coupled to the optical assembly 326, to an SLM 330, and to projection optics 332. The reflected light 344 and 346 from the optical assembly propagate through the prism 328 to the SLM 330. The SLM 330 may be an example of the SLM 108 illustrated in FIG. 1. The SLM 330 may be a DMD device, an LCoS device, and LCD, or another SLM. The SLM 330 has an array of pixels that produces an image of modulated light 362 and 364, respectively based on receiving the reflected light 344 and 346. The modulated light 362 and the modulated light 364 propagates into the prism 328, is reflected off of a surface, and transmitted by another surface towards the projection optics 332.

The projection optics 332 transmits the modulated light towards a waveguide 342. The projection optics 332 may be an example of the projection optics 110 illustrated in FIG. 1. The projection optics 332 includes a lens 334, a lens 336, a lens 338, and a lens 340. The projection optics 332 is illustrated as having four lenses, but it may have fewer lenses, for example one lens, two lenses, or three lenses, or more lenses, for example five lenses, six lenses, or more lenses. The waveguide 342 may be an example of the waveguide 112 illustrated in FIG. 1. The light from the projection optics 332 enters the waveguide 342 via a coupler 366. The light from the waveguide then enters a pupil of an eye of a user (not pictured).

FIG. 4 illustrates an additional near-eye display 400 with an LED illumination source 430. The near-eye display 400 may be an example of the near-eye display 100 illustrated in FIG. 1. In an example, a wearable device contains two of near-eye display 400, one for each eye. The LED illumination source 430 may be an example of the LED illumination source 102 illustrated in FIG. 1, the LED illumination source 200 illustrated in FIG. 2A, or the LED illumination source 240 illustrated in FIG. 2F.

The LED illumination source 430 contains an LED assembly 402, a lens assembly 404, a reflective element 406, and a homogenizing element 412. The LED assembly 402 may include the LED assembly 203 illustrated in FIG. 2B, the LED assembly 205 illustrated in FIG. 2C, the LED assembly 207 illustrated in FIG. 2D, or the LED assembly 209 illustrated in FIG. 2E. The LED assembly 402 contains four LEDs in a square configuration. Two LEDs are in column 446 that produce light 431 and two LEDs are in column 448 and produce light 432. In an example, the LED illumination source 430 contains two LEDs in a column 446 and two LEDs in a column 448. In one example, the column 446 has a first LED in a first quadrant and a second LED in a second quadrant adjacent the first quadrant. The first LED produces first light having a first color, for example red light or blue light, and the second LED produces second light having a second color different than the first color, for example blue light or red light. In this example, the column 448 has a third LED in a third quadrant adjacent the second quadrant and a fourth LED in a fourth quadrant adjacent the third quadrant and the first quadrant. The third LED and the fourth LED produce third light and fourth light, respectively, having a third color different than the first color and the second color, for example green. In another example, the column 448 has a first LED in a first quadrant and a second LED in the second quadrant, the second quadrant adjacent the first quadrant. The first LED produces first light having a first color, for example red or blue, and the second LED produces second light having a second color different than the first color, for example blue or red. The column 446 has a third LED in a third quadrant adjacent the second quadrant and a fourth LED in a fourth quadrant adjacent the third quadrant and the first quadrant. The third LED is configured to produce third light having a third color different than the first color and the second color, for example green, and the fourth LED is configured to produce fourth light having the third color, for example green.

The lens assembly 404 is optically coupled to the LED assembly 402. The lens assembly 404 is pictured with one lens, but it may have more lenses, for example two lenses or three lenses. The lens assembly 404 focuses the light 431 to produce focused light 434. Also, the lens assembly 404 focuses the light 432 to produce focused light 436.

The reflective element 406 is optically coupled to the lens assembly 404 and to the homogenizing element 412. The reflective element 406 has a reflective surface 408 and a reflective surface 410. In one example, the reflective surface 408 and the reflective surface 410 are reflective plates, where the reflective surface 410 is spaced away from the reflective surface 408, for example by an air gap. In other examples, the reflective element 406 is a glass or plastic element, and the reflective surface 410 and the reflective surface 408 are reflective surfaces on the glass or plastic element. The reflective surface 408 reflects the focused light 434 to produce reflected light 438. The reflective surface 408 also transmits the focused light 436, which is reflected by the reflective surface 410 and again transmitted by the reflective surface 408 to produce reflected light 440.

The homogenizing element 412 is optically coupled to the reflective element 406. The homogenizing element 412 may be a fly's eye array or a light tunnel. The homogenizing element 412 homogenizes the reflected light 438, to produce output light 442. The homogenizing element 412 also homogenizes the reflected light 440 to produce output light 444.

A lens 414, a lens 416, and a cover prism 418 may be an example of the illumination optics 104 illustrated in FIG. 1. The lens 414, the lens 416, and the cover prism 418 direct the output light 442 and the output light 444 towards a prism 418. The prism 420 may be an example of the coupling element 106 illustrated in FIG. 1. The prism 420 directs the output light 442 and the output light 444 towards an SLM 422. The SLM 422 may be an example of the SLM 108 illustrated in FIG. 1. The SLM 422 may be a DMD device, an LCoS device, and LCD, or another SLM. The SLM 422 has an array of pixels that produces an image in modulated light 450 and 452, respectively, based on receiving the output light 442 and 444. The modulated light 450 and the modulated light 452 propagates into the prism 420, is reflected off of a surface, and transmitted by another surface towards freeform optics 4240.

Freeform optics 424 is optically coupled to the prism 420 and to a waveguide 426. The freeform optics 424 may be an example of the projection optics 110 illustrated in FIG. 1. The modulated light 450 and the modulated light 452 enters the freeform optics 424, reflects of at least two surfaces, and is transmitted to the waveguide 426 via a coupler 428. The waveguide 426 may be an example of the waveguide 112 illustrated in FIG. 1. The modulated light enters the waveguide 426 from the freeform optics 424 via a coupler 428. The modulated light is then viewed by an eye.

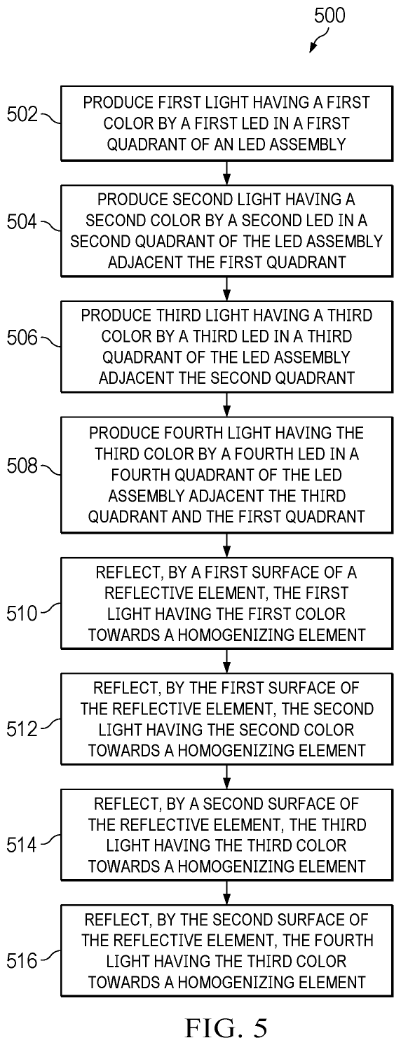

FIG. 5 illustrates a flowchart 500 for an embodiment method of LED illumination. In an example, block 502, block 504, and block 506 are performed sequentially, and block 506 and block 508 are performed simultaneously. In block 502, a first LED in a first quadrant of an LED assembly produces first light having a first color. In block 504, a second LED in a second quadrant of the LED assembly adjacent the first quadrant produces first light having a second color different than the first color. In block 506, a third LED in a third quadrant of the LED assemble adjacent the second quadrant produces third light having a third color different than the first color and the second color. In block 508, a fourth LED in a fourth quadrant of the LED assembly adjacent the third quadrant and the first quadrant produces fourth light having the third color. In one example, the first color is red, the second color is blue, and the third color is green. In another example, the first color is blue, the second color is red, and the third color is green. In one example, the first LED is LED 236, the second LED is LED 234, the third LED is 230, and the fourth LED is LED 232, illustrated in FIG. 2B. In another example, the first LED is LED 234, the second LED is LED 236, the third LED is LED 232, and the fourth LED is LED 230, illustrated in FIG. 2B. In an additional example, the first LED is LED 262, the second LED is LED 260, the third LED is LED 266, and the fourth LED is LED 264, illustrated in FIG. 2C. In another example, the first LED is LED 260, the second LED is LED 262, the third LED is LED 264, and the fourth LED is LED 266, illustrated in FIG. 2C. In an example, the first LED is LED 272, the second LED is LED 273, the third LED is LED 270, and the fourth LED is LED 271, illustrated in FIG. 2D. In another example, the first LED is LED 273, the second LED is LED 272, the third LED is LED 271, and the fourth LED is LED 270, illustrated in FIG. 2D. In an additional example, the first LED is LED 297, the second LED is LED 298, the third LED is LED 295, and the fourth LED is LED 296, illustrated in FIG. 2E. In an example, the first LED is LED 298, the second LED is LED 297, the third LED is LED 296, and the fourth LED is LED 295, illustrated in FIG. 2E.

In block 510, a first surface of a reflective element reflects the first light having the first color towards a homogenizing element. In block 512, the first surface of the reflective element reflects the second light having the second color towards the homogenizing element. In block 514, a second surface of the reflective element reflects the third light having the third color towards the homogenizing element. In block 516, the second surface of the reflective element reflects the fourth light having the fourth color towards the homogenizing element. In one example, the first surface is surface 210 and the second surface is surface 212, illustrated in FIG. 2A. In another example, the first surface is surface 212 and the second surface is surface 210, illustrated in FIG. 2A.

Moreover, the scope of the present application is not intended to be limited to the particular illustrative example arrangement of the process, machine, manufacture, and composition of matter means, methods and steps described in this specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding example arrangements described herein may be utilized according to the illustrative arrangements presented and alternative arrangements described, suggested or disclosed. Accordingly, the appended claims are intended to include within their scope such processes, machines, manufacture, compositions of matter, means, methods, or steps.

What is claimed is:

1. A system comprising:
a light emitting diode (LED) assembly comprising:
a first LED in a first quadrant of the LED assembly, the first LED configured to produce first light having a first color;
a second LED in a second quadrant of the LED assembly adjacent the first quadrant, the second LED configured to produce second light having a second color;
a third LED in a third quadrant of the LED assembly adjacent the second quadrant, the third LED configured to produce third light having a third color; and
a fourth LED in a fourth quadrant of the LED assembly adjacent the third quadrant and the first quadrant, the fourth LED configured to produce fourth light having the third color;
a homogenizing element; and
a reflective element having a first surface and a second surface, the reflective element optically coupled to the LED assembly and to the homogenizing element, the first surface configured to reflect the first light having the first color towards the homogenizing element and to reflect the second light having the second color towards the homogenizing element, and the second surface configured to reflect the third light having the third color towards the homogenizing element and to reflect the fourth light having the third color towards the homogenizing element.

2. The system of claim 1, wherein the first color is red, the second color is blue, and the third color is green.

3. The system of claim 1, wherein the reflective element comprises a transmissive element having a first side and a second side, the first surface comprising a first reflective coating on the first side of the transmissive element and the second surface comprising a second reflective coating on the second side of the transmissive element.

4. The system of claim 1, wherein the first surface of the reflective element is a first reflective plate and the second surface of the reflective element is a second reflective plate spaced from the first reflective plate.

5. The system of claim 1, wherein the first surface of the reflective element is configured to transmit the third light having the third color towards the second surface of the reflective element and to transmit the fourth light having the third color towards the second surface of the reflective element.

6. The system of claim 1, wherein the second surface of the reflective element is configured to transmit the first light having the first color towards the first surface of the reflective element and to transmit the second light having the second color towards the first surface of the reflective element.

7. The system of claim 1, wherein the homogenizing element comprises a fly's eye array.

8. A near-eye display comprising:
a light emitting diode (LED) assembly comprising:
a first LED in a first quadrant of the LED assembly, the first LED configured to produce first light having a first color;
a second LED in a second quadrant of the LED assembly adjacent the first quadrant, the second LED configured to produce second light having a second color;
a third LED in a third quadrant of the LED assembly adjacent the second quadrant, the third LED configured to produce third light having a third color; and
a fourth LED in a fourth quadrant of the LED assembly adjacent the third quadrant and the first quadrant, the fourth LED configured to produce fourth light having the third color;
a homogenizing element;
a reflective element having a first surface and a second surface, the reflective element optically coupled to the LED assembly and to the homogenizing element, the first surface configured to reflect the first light having the first color towards the homogenizing element and to reflect the second light having the second color towards the homogenizing element, and the second surface configured to reflect the third light having the third color towards the homogenizing element and to reflect the fourth light having the third color towards the homogenizing element;
illumination optics optically coupled to the homogenizing element;
a spatial light modulator (SLM);
projection optics;
a prism optically coupled to the illumination optics, to the SLM, and to the projection optics; and
a waveguide optically coupled to the projection optics.

9. The near-eye display of claim 8, wherein the first color is red, the second color is blue, and the third color is green.

10. The near-eye display of claim 8, wherein the reflective element comprises a transmissive element having a first side and a second side, the first surface comprising a first reflective surface on the first side of the transmissive element and the second surface comprising a second reflective coating on the second side of the transmissive element.

11. The near-eye display of claim 8, wherein the first surface of the reflective element comprises a first reflective plate and the second surface of the reflective element comprises a second reflective plate.

12. The near-eye display of claim 8, wherein the first surface of the reflective element is configured to transmit the third light having the third color towards the second surface of the reflective element and to transmit the fourth light having the third color towards the second surface of the reflective element.

13. The near-eye display of claim 8, wherein the second surface of the reflective element is configured to transmit the first light having the first color towards the first surface of the reflective element and to transmit the second light having the second color towards the first surface of the reflective element.

14. The near-eye display of claim 8, wherein the homogenizing element comprises a fly's eye array.

15. A method comprising:
producing, by a first light emitting diode (LED) in a first quadrant of an LED assembly, first light having a first color;
producing, by a second LED in a second quadrant of the LED assembly adjacent the first quadrant, second light having a second color;
producing, by a third LED in a third quadrant of the LED assembly adjacent the second quadrant, third light having a third color;
producing, by a fourth LED in a fourth quadrant of the LED assembly adjacent the third quadrant and the first quadrant, fourth light having the third color;
reflecting, by a first surface of a reflective element, the first light having the first color towards a homogenizing element;
reflecting, by the first surface of the reflective element, the second light having the second color towards the homogenizing element;
reflecting, by a second surface of the reflective element, the third light having the third color towards the homogenizing element; and
reflecting, by the second surface of the reflective element, the fourth light having the third color towards the homogenizing element.

16. The method of claim 15, wherein the first color is red, the second color is blue, and the third color is green.

17. The method of claim 15, wherein the reflective element comprises a transmissive element having a first side and a second side, the first surface comprises a first reflective coating on the first side of the transmissive element and the second surface comprises a second reflective coating on the second side of the transmissive element.

18. The method of claim 15, wherein the first surface of the reflective element comprises a first reflective plate and the second surface of the reflective element comprises a second reflective plate.

19. The method of claim 15, further comprising:
transmitting, by the first surface of the reflective element the third light having the third color towards the second surface of the reflective element; and
transmitting, by the first surface of the reflective element, the fourth light having the third color towards the second surface of the reflective element.

20. The method of claim 15, further comprising:
transmitting, by the second surface of the reflective element, the first light having the first color towards the first surface of the reflective element; and
transmitting, by the second surface of the reflective element, the second light having the second color towards the first surface of the reflective element.
